(19) United States
(12) Patent Application Publication
(10) Pub. No.: US 2023/0347762 A1
(43) Pub. Date: Nov. 2, 2023

(54) SYSTEMS AND METHODS FOR DEPLOYMENT OF AN ELECTRIC VEHICLE CHARGER SYSTEM

(71) Applicant: SHOALS TECHNOLOGIES GROUP, LLC, Portland, TN (US)

(72) Inventors: Jeffery J. TOLNAR, Portland, TN (US); Steven P. GREENWELL, Portland, TN (US); Benard A. DOMNING, Portland, TN (US); Dean SOLON, Gallatin, TN (US)

(21) Appl. No.: 18/309,766

(22) Filed: Apr. 28, 2023

Related U.S. Application Data
(60) Provisional application No. 63/363,924, filed on Apr. 29, 2022.
(60) Provisional application No. 63/367,022, filed on Jun. 24, 2022.
(60) Provisional application No. 63/379,616, filed on Oct. 14, 2022.

(51) Int. Cl. B60L 53/18; B60L 53/34

(52) U.S. Cl. CPC B60L 53/18; B60L 53/34; B60L 2210/00

(57) ABSTRACT

In an example, a system to charge electric vehicles includes a power platform, a cable management system (CMS), two or more lead assemblies, and a charger platform. The power platform is configured to receive input power, to generate output power from the input power, and to electrically protect the lead assemblies and the charger platform. The CMS extends from the power platform. The lead assemblies each include a feeder cable electrically coupled to the power platform. The lead assemblies also include a drop line electrically coupled to the feeder cable. Additionally, the lead assemblies are disposed in the CMS. The charger platform is configured to interface with the CMS and support a charging device. The charging device is electrically coupled to the drop line. The charging device includes an electric vehicle charger that is configured to deliver the output power to an electric vehicle.

### CROSS-REFERENCE TO RELATED APPLICATIONS

This application claims the benefit of and priority to U.S. Provisional App. No. 63/363,924 filed on Apr. 29, 2022, U.S. Provisional App. No. 63/367,022 filed on Jun. 24, 2022, and U.S. Provisional App. No. 63/379,616 filed on Oct. 14, 2022, each of which is incorporated herein by reference in its entirety.

### FIELD

Embodiments described herein relate to systems and methods for deployment of an electric vehicle charger system.

### BACKGROUND

Unless otherwise indicated in the present disclosure, the materials described in the present disclosure are not prior art to the claims in the present application and are not admitted to be prior art by inclusion in this section.

Typical electric vehicles (EVs) operate on large on-board energy storage cells or rechargeable batteries. EV battery capacity limits the distances EVs can travel on a single charge from and/or between a user's home EV charger system and commercial EV charger systems (e.g., charging stations). Commercial EV charger infrastructure has historically included sparsely located EV charger systems at haphazard or ad hoc locations. The sparsity of commercial EV charger infrastructure is an impediment to the widespread adoption of EVs.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In an example embodiment, a system to charge electric vehicles includes a power platform, a cable management system (CMS), two or more lead assemblies, and a charger platform. The power platform is configured to receive input power, to generate output power from the input power, and to electrically protect the charger platform and the lead assemblies. The CMS extends from the power platform. The lead assemblies each include a feeder cable electrically coupled to the power platform. The lead assemblies also include a drop line electrically coupled to the feeder cable. Additionally, the lead assemblies are disposed in the CMS. The charger platform is configured to interface with the CMS and support a charging device. The charging device is electrically coupled to the drop line. The charging device includes an electric vehicle charger that is configured to deliver the output power to an electric vehicle.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A illustrates a block diagram of an example EV charger system;

FIG. 1B illustrates a block diagram of another example EV charger system;

FIG. 1C illustrates a block diagram of another example EV charger system;

FIG. 1D includes an exploded perspective view of an example of a ramped cable management system that may be included in any of the EV charger systems herein;

FIG. 2 illustrates a perspective view of another example EV charger system;

FIGS. 3A, 3B, 3C, and 3D illustrate an example cable management system that may be included in any of the EV charger systems herein;

FIG. 4 illustrates a lead assembly including a single drop line per electrical nexus with a fuse in line with the drop lines; and

FIG. 5 illustrates dual drop lines associated with an electrical nexus,

all arranged in accordance with at least one embodiment described herein.

### DESCRIPTION OF EMBODIMENTS

Approximately half of an EV infrastructure deployment cost is associated with temporal aspects of the deployment: power entry equipment, cables, skids, extensive civil work, and long cable runs and connectors. To meet EV deployment goals, charge point operators need to speed deployment while simultaneously reducing costs. Embodiments herein relate to an EV charger system having components that may reduce installation times and/or costs compared to other EV charger systems. The system described herein and/or some of its components may be preassembled and/or quickly assembled using modular components. The modular components may cost less, use less site preparation prior to installation, be readily portable, and/or offer availability to change scale in an amount of EV chargers supported.

Embodiments of the present disclosure will be explained with reference to the accompanying drawings.

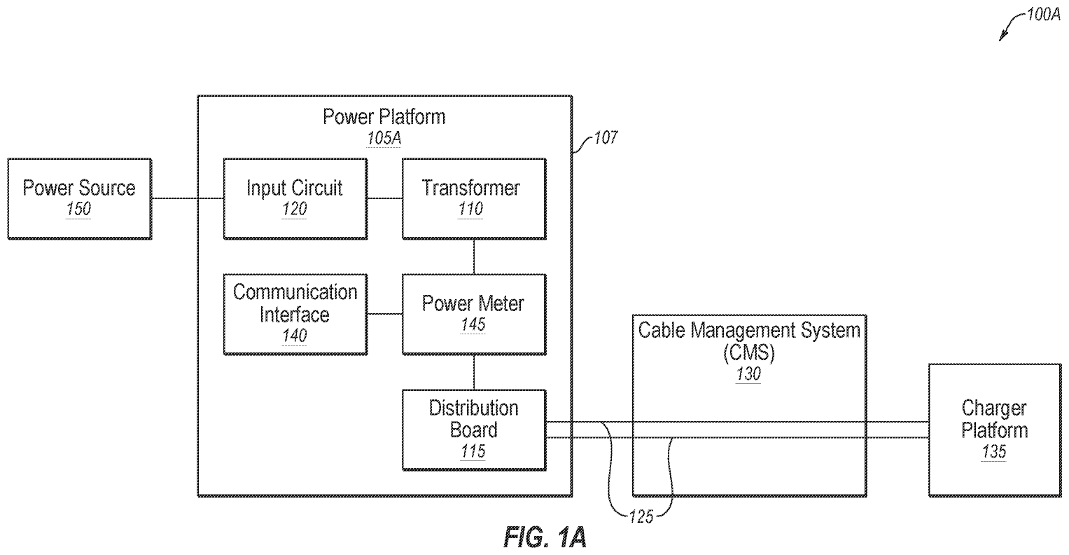

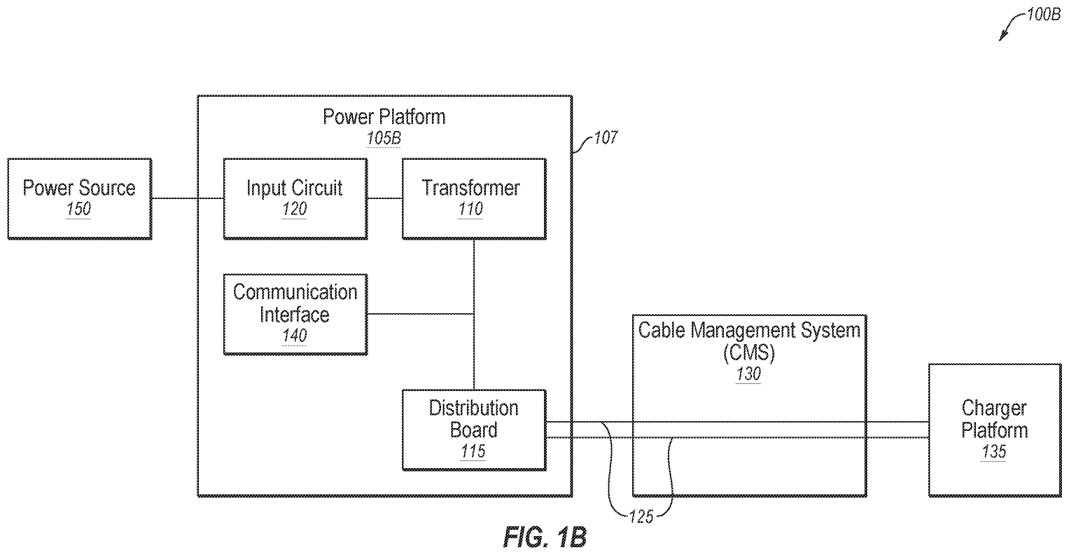

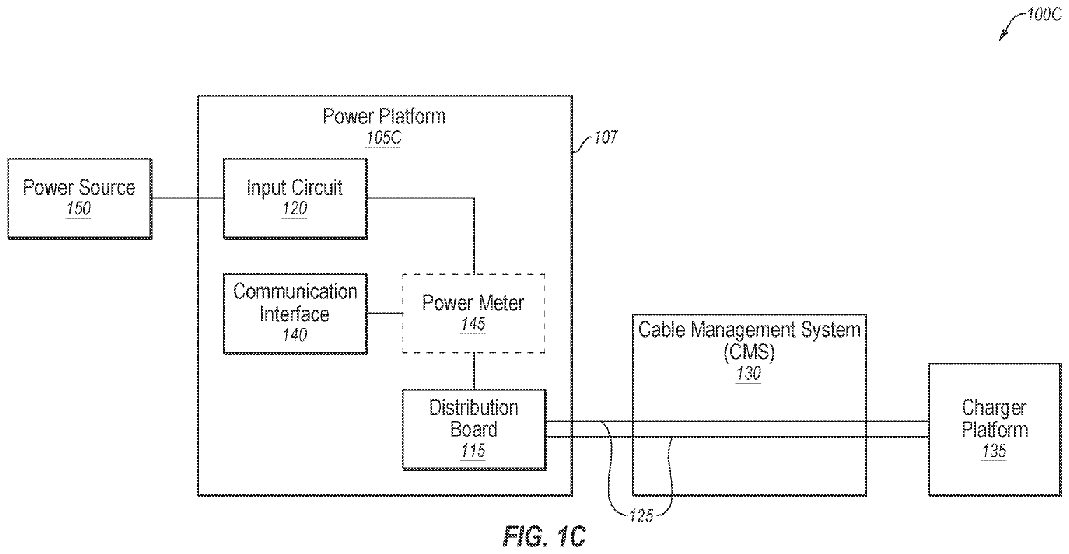

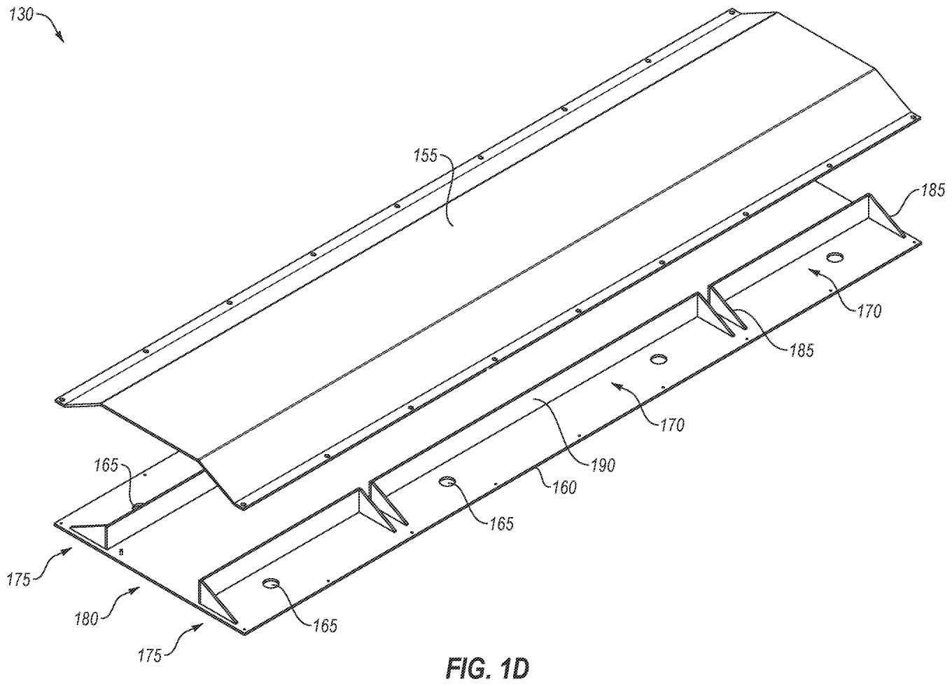

FIG. 1A illustrates a block diagram of an example EV charger system 100A (hereinafter “system 100A”), arranged in accordance with at least one embodiment described herein. In some embodiments, the system 100A may include an EV charger station power platform 105A (hereinafter “power platform 105A”), two or more lead assemblies 125, a cable management system (CMS) 130, and one or more charger platforms 135. The power platform 105A may include a transformer 110, a distribution board 115, an input circuit 120, a communication interface 140, and/or a power meter 145.

In general, the power platform 105A may receive and condition power from a power source 150 for use by the charger platform 135 to charge an EV. The distribution board 115 may provide electrical protection for the CMS and/or the charger platforms 135. The lead assemblies 125 electrically couple the power platform 105A to the charger platforms 135. In some embodiments, the system 100A may be a direct current (DC) powered system. For example, one lead assembly 125 may be a positive lead assembly connected to a positive lead of each charger platform 135 and one lead assembly 125 may be a negative lead assembly connected to a negative lead of each charger platform 135. In some embodiments, the system 100A may be an alternating current (AC) powered system. For example, the lead assemblies 125 may be arranged to support single phase AC power (e.g., using a first lead assembly and a second lead assembly) and/or arranged to support three phase AC power (e.g., using a first lead assembly, a second lead assembly, a third lead assembly, and a neutral line).

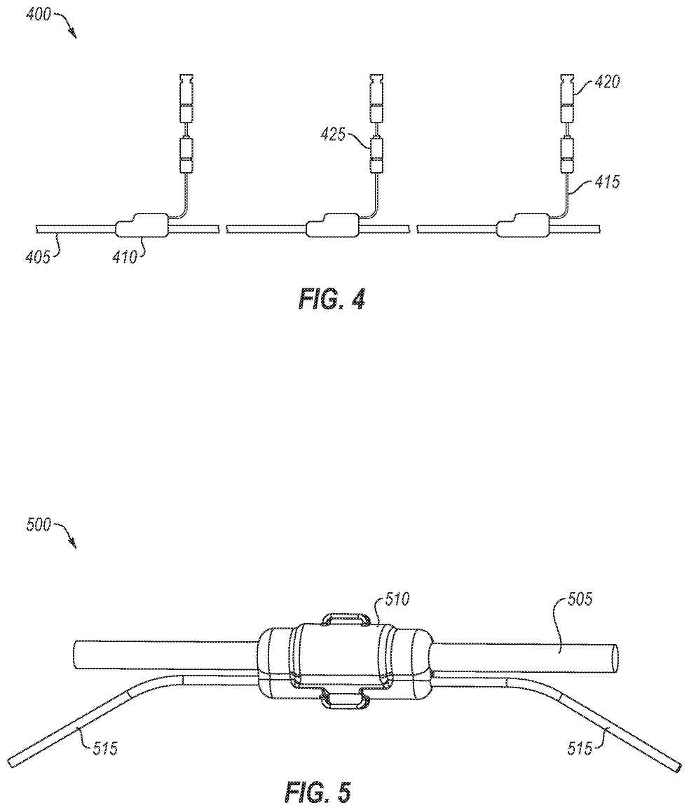

In these and other embodiments, the lead assemblies 125 may include a Lead Assembly as illustrated in FIGS. 4 and 5 of the present application and further described in U.S. Pat. No. 10,992,254 issued Apr. 27, 2021, and titled LEAD ASSEMBLY FOR CONNECTING SOLAR PANEL ARRAYS TO INVERTER, which is incorporated herein by reference in its entirety for all purposes.

Alternatively, or additionally, the lead assemblies 125 may include one or more “home run” cables. The home run cables may electrically couple the power platform 105A to the charger platforms 135, where each charger platform of the charger platforms 135 may include a distinct home run cable which may electrically couple to the power platform 105A.

Alternatively, or additionally, one of the lead assemblies 125 may be the current supply conveying the output power from the power platform 105A to the charger platforms 135 and the other lead assembly 125 may be the current return. The CMS 130 may enclose and protect the lead assemblies 125, enabling above-ground wiring runs that do not require the time or cost of trenching and/or fishing wiring through conduit. The charger platforms 135 are configured to charge EVs, or more particularly batteries of the EVs.

The power platform 105A may be configured to receive input power, e.g., from the power source 150, and generate output power for operation of the charger platforms 135. For example, the power platform 105A may receive and transform an input power having a first current and voltage to an output power having a second current and voltage that is different from the first current and voltage. Instead of or in addition to transforming voltage, the power platform 105A may convert AC input power to DC output power, in which case the power platform 105A may be or include an AC-to-DC converter, or may convert DC power to AC power, in which case the power platform 105A may be or include a DC-to-AC converter. In some embodiments, the output power may be or include DC power to charge batteries, such as EV batteries. In some embodiments, the output power may be or include AC power provided to the charger platforms 135 which may convert the AC power to DC power to charge EV batteries.

In some embodiments, the power platform 105A may include interlocking, plug-and-play components that may be modularly assembled. For example, the power platform 105A may include two or more of the transformer 110, the distribution board 115, the input circuit 120, the communication interface 140, and/or the power meter 145, each of which may interlock with one or more of the other components. In some embodiments, the transformer 110, the distribution board 115, the input circuit 120, the communication interface 140, and/or the power meter 145 may be assembled to form the power platform 105A prior to installation of the power platform 105A in an operational location. For example, the transformer 110, the distribution board 115, the input circuit 120, the communication interface 140, and/or the power meter 145 may be assembled into the power platform 105A in a factory setting prior to the deployment of the power platform 105A for use in the operational location. Alternatively, or additionally, the transformer 110, the distribution board 115, the input circuit 120, the communication interface 140, and/or the power meter 145 may be assembled as part of an installation of the power platform 105A for use in the operational location and/or at other time or location apart from a factory and/or operational location. For example, each of the transformer 110, the distribution board 115, the input circuit 120, the communication interface 140, and/or the power meter 145 may be received at the operational location (or other location) and may be assembled into the power platform 105A as part of and/or in advance of an installation thereof.

In an example embodiment, the power platform 105A (or other power platforms herein) is assembled as follows, not necessarily in the following order or including every single step. The transformer 110 is coupled to the base 107 at an assembly site that is different than an installation site of the power platform 105A. The power meter 145 is coupled to the base 107 and is electrically coupled to the transformer 110 at the assembly site. The distribution board is coupled to the base 107 at the assembly site. The distribution board 115 is electrically coupled to the transformer 110 at the assembly site. The communication interface 140 is coupled to the base 107 and is electrically coupled to the power meter 145, the transformer 110, and/or the distribution board 115 at the assembly site. The base 107, the transformer 110, the power meter 145, the distribution board 115, and/or the communication interface 140 (and/or other components such as the input circuit 120) collectively form the power platform 105A. After assembly at the assembly site, in some embodiments the assembled power platform 105A may be transported to the installation site and then may be installed at the installation site. Installing the power platform 105A at the installation site may include electrically coupling the power platform 105A, and more specifically the transformer 110 (e.g., through the input circuit 120), to the power source 150 and/or mechanically coupling the power platform 105A to the installation site (e.g., using screws, earth screws, masonry screws, bolts, lag bolts, anchors, concrete anchors, expanding anchors, nails, or the like).

In some embodiments, one or more electrical lines may electrically couple the transformer 110, the distribution board 115, the input circuit 120, the communication interface 140, and the power meter 145 of the power platform 105A. Alternatively, or additionally, the one or more electrical lines may individually or collectively couple the transformer 110, the distribution board 115, the input circuit 120, the communication interface 140, and the power meter 145 to a feeder cable of the lead assemblies 125, such as the feeder cable 405 of FIG. 4. In some embodiments, a jumper may be coupled between the one or more electrical lines and the feeder cable of the lead assemblies 125. Additional details associated with the feeder cable and/or jumper and the operation thereof are further disclosed in and described with respect to FIG. 4.

In some embodiments, the transformer 110 of the power platform 105A may be configured to perform a transformation of an input power to an output power. For example, an input AC power may be received having a first voltage and current and the transformer 110 may convert the input AC power to an output AC or DC power having a second voltage and current that are different than the first voltage and current. In these and other embodiments, the transformer 110 may be electrically coupled to and receive input power from the power source 150 which may include a solar array, an electrical grid, or other power source. For example, the transformer 110 may include an EATON 300 kilovolt-ampere (kVA) general purpose ventilated transformer (item number V48M28T33EE) having a primary voltage of 480 volts (V) and a secondary voltage of 208 Y/120 V. The forgoing transformer is provided only as an example, as the transformer 110 may include any other transformer which may include the same or different primary voltage, secondary voltage, make, and/or model.

In some embodiments, the distribution board 115 distributes output power from the transformer 110 to the charger platform(s) 135 through the lead assemblies 125 and may generally include electrical supply components, including utility/supply/load conductors (e.g., wires or busbars), load side circuit breakers (e.g., one for each lead assembly 125), or the like, electrically coupled between the power platform 105A and the lead assemblies 125. The charger platform(s) 135 is(are) an example of a load of the power platform 105A. In other embodiments, the power platform 105A may have a different load.

Each load side circuit breaker of the distribution board 115 may be electrically coupled between the transformer 110 and a corresponding lead assembly 125. Each load side circuit breaker may include an electrical switch that includes an open configuration and a closed configuration. In the open configuration of a given load side circuit breaker, the transformer 110 may be electrically decoupled from a corresponding lead assembly 125 and a set of one or more corresponding charger platforms 135 that are all electrically coupled to the lead assembly 125. In the closed configuration of the given load side circuit breaker, the transformer 110 may be electrically coupled to the corresponding lead assembly 125 and the set of corresponding charger platforms 135. In these and other embodiments, the load side circuit breakers of the distribution board 115 may be configured to protect at least the lead assemblies 125, such as from a short circuit or an overcurrent, by tripping and disconnecting the lead assemblies 125 from the power platform 105A.

Each load side circuit breaker may be tripped (switched from closed to open) and/or reset (e.g., switched from open to closed) automatically or manually. For example, a given load side circuit breaker may trip automatically in response to an over current condition or short circuit to prevent or reduce damage to the system 100A or EV(s) being charged and/or may be reset automatically when the over current condition or short circuit is resolved. As another example, a given load side circuit breaker may be tripped manually by a laborer or other person to inspect, service, or otherwise interact with the lead assemblies 125, a set of corresponding charger platforms 135, and/or other component downstream of the load side circuit breaker, and may be reset manually by the laborer or other person when finished with inspecting, servicing, or otherwise interacting with the lead assemblies 125, the set of corresponding charger platforms 135, and/or other component downstream of the load side circuit breaker.

In some embodiments, the input circuit 120 may be electrically coupled between the transformer 110 and the power source 150. The input circuit 120 may include an electrical safety switch, a main lug only pull section, a disconnect panel, a 208 V panel on a quick connect board (QCB), or other suitable input circuit. When implemented as an electrical safety switch or disconnect panel (that may include, e.g., a circuit breaker), the input circuit 120 may include an electrical switch that includes an open configuration and a closed configuration. In the open configuration, the transformer 110 may be electrically decoupled from the power source 150. In the closed configuration, the transformer 110 may be electrically coupled to the power source 150.

In some embodiments, the electrical switch of the input circuit 120 may be manually operated by a user. For example, the user may disconnect the power platform 105A from the power source 150 by setting the electrical switch of the input circuit 120 to the open configuration, which may permit the user to safely service or otherwise interact with the transformer 110 and/or any electrical component downstream therefrom. In another example, the user may transition the electrical switch of the input circuit 120 from the open configuration to the closed configuration. Alternatively, or additionally, the electrical switch of the input circuit 120 may be automatically operated, such as in response to a catalyst. For example, in response to the transformer 110 becoming damaged or inoperable or the input circuit 120 detecting an overcurrent, the electrical switch of the input circuit 120 may transition from the closed configuration to the open configuration, which may reduce or prevent damage to the transformer 110 and/or other components in the system 100A. In another example, after a period of time, or in response to a signal from the transformer 110 or other components in the system 100A, the electrical switch of the input circuit 120 may transition from the open configuration to the closed configuration. In some embodiments in which the input circuit 120 includes an electrical safety switch, the input circuit 120 may include a CUTLER HAMMER DH Series safety switch (part number DH365FRK) having an operating voltage of 600 V and a current rating of 400 amps (A), or other suitable electrical safety switch.

The power meter 145 is coupled to the base 107 and is electrically coupled to and between the transformer 110 and the distribution board 115. The power meter 145 may be configured to measure power consumption or usage through the power platform 105A. In some embodiments, the power meter 145 records consumption or usage and communicates the information to a power utility for monitoring and billing. For example, the power meter 145 may communicate the information to the power utility via the communication interface 140.

The communication interface 140 may communicatively couple the power platform 105A to a communication network. In general, the network may include one or more wide area networks (WANs) and/or local area networks (LANs) that enable the power platform 105A to communicate with other entities (e.g., a server of or associated with the power utility). In some embodiments, the network may include the Internet, including a global internetwork formed by logical and physical connections between multiple WANs and/or LANs. Alternately or additionally, the network may include one or more cellular radio frequency (RF) networks and/or one or more wired and/or wireless networks such as 802.xx networks, Bluetooth access points, wireless access points, Internet Protocol (IP)-based networks, or other wired and/or wireless networks. The network may also include servers that enable one type of network to interface with another type of network. Accordingly, the communication interface 140 may include an Ethernet chip, a Wi-Fi chip, a cellular radio, or other suitable communication interface.

As previously indicated, the lead assemblies 125 may be electrically coupled to the power platform 105A through the distribution board 115. That is, the lead assemblies 125 may be electrically coupled to the transformer 110 with the distribution board 115 electrically disposed between the lead assemblies 125 and the transformer 110 as described herein.

In some embodiments, the lead assemblies 125 include distribution cables or power cables. Alternatively or additionally, the lead assemblies 125 may each include a feeder cable, one or more drop lines, one or more drop line connectors, and/or one or more in-line fuses. Alternatively, or additionally, the lead assemblies may include one or more load side breakers and/or in-line fuses, e.g., electrically coupled between the feeder cable and the drop lines, to electrically protect the drop lines and the chargers. Each lead assembly 125 may be configured to transmit the output power from the power platform 105A to the charger platforms 135 or return current from the charger platforms 135 to the power platform 105A. Example details regarding each lead assembly 125, including the components of each lead assembly 125 and associated operations, are further disclosed in and discussed with respect to FIGS. 4 and 5 herein.

In some embodiments, the CMS 130 may extend from the power platform 105A to the charger platforms 135. A base of the power platform 105A and/or a base of the charger platform 135 may include cutouts to receive therein ends of one or more raceways included in the CMS 130. Alternatively, or additionally, the CMS 130 may extend between charger platforms 135 to support multiple charger platforms 135, and/or in anticipation of installation of additional charger platforms 135. The CMS 130 may be sized and shaped to receive two or more lead assemblies 125 and may provide at least one channel for the lead assemblies 125 to travel from the power platform 105A to the charger platforms 135. Additional channels or a single enlarged-capacity channel may be included in the CMS 130 to support additional lead assemblies 125 and/or other support cables and/or wires in the system 100A.

In these and other embodiments, the CMS 130 may be configured to support a weight from an external source and protect the lead assemblies 125 disposed therein from damage, such as from being crushed. For example, the CMS 130 may be configured to support the weight of one or more persons standing thereon without crushing the lead assemblies 125 disposed therein. In another example, the CMS 130 may be configured to support the weight of one or more cars that may drive over the CMS 130 without crushing the lead assemblies 125 disposed therein. Alternatively, or additionally, the CMS 130 may be ramped along its long edges to facilitate driving over the CMS 130.

FIG. 1D includes an exploded perspective view of an example of such a ramped CMS 130 that may be implemented in any of the EV charger systems herein, arranged in accordance with at least one embodiment herein. In FIG. 1D, the CMS 130 includes a top shell 155 and a bottom shell 160. The bottom shell 160 defines various through holes 165 (only some of which are labeled for simplicity) through which fasteners (e.g., earth screws, screws, bolts, etc.) may be inserted to secure the CMS 130 to the ground, a parking surface, etc. The bottom shell 160 additionally includes various U-shaped ridge structures 170 (only some of which are labeled for simplicity) extending upward from the bottom shell 160 and aligned in rows 175. The two rows 175 of U-shaped ridge structures 170 define a channel 180 to receive one or more lead assemblies 125 or home run cables therein. The top shell 155 may then be coupled to the bottom shell 160 (e.g., using screws, bolts, nuts, adhesive, or other fastener) to enclose the lead assemblies 125 or home run cables therein. In FIG. 1D, each U-shaped ridge structure 170 includes two ramped ends 185 (only some of which are labeled for simplicity) arranged generally orthogonal to a connection portion therebetween 190 (only some of which are labeled for simplicity). The U-shaped ridge structures 170 support the top shell 155 and prevent, or at least reduce the likelihood of, the top shell 155 collapsing (and thereby crushing the lead assemblies) when a vehicle or other object drives over or otherwise loads the CMS 130 of FIG. 1D. While illustrated with one channel 180 defined by two rows 175 of U-shaped ridge structures 170, more generally the CMS 130 depicted in FIG. 1D may include one or more channels, each sized to receive therein one or more lead assemblies or home run cables. In embodiments with more than one channel, the CMS 130 may include one or more additional rows of one or more ridge structures (not necessarily U-shaped ridge structures) positioned between the rows 175 of U-shaped ridge structures 170, where each pair of spaced apart rows of U-shaped and/or other-shaped ridge structures defines a channel therebetween.

Returning to FIG. 1A, in some embodiments, the CMS 130 may extend from the power platform 105A to the charger platforms 135. A base of the power platform 105A and/or a base of the charger platform 135 may include cutouts to receive therein ends of one or more raceways included in the CMS 130. Alternatively, or additionally, the CMS 130 may extend between charger platforms 135 to support multiple charger platforms 135, and/or in anticipation of installation of additional charger platforms 135. The CMS 130 may be sized and shaped to receive two or more lead assemblies 125 and may provide at least one channel for the lead assemblies 125 to travel from the power platform 105A to the charger platforms 135. Additional channels or a single enlarged-capacity channel may be included in the CMS 130 to support additional lead assemblies 125 and/or other support cables and/or wires in the system 100A.

In some embodiments, the CMS 130 may extend from the power platform 105A to the charger platforms 135 or between charger platforms 135 in a continuous trajectory and/or on the same surface on which the power platform 105A is installed or located. For example, the CMS 130 may extend in a straight line on a surface on which the power platform 105A is located, and from the power platform 105A to the charger platforms 135. Alternatively, or additionally, one or more raceways included in the CMS 130 may include corners, bends, curves, etc., in extending between the power platform 105A and the charger platforms 135. For example, the power platform 105A may be installed on a garage floor, the charger platform 135 may be disposed on the garage wall, and a raceway of the CMS 130 may include a bend, curve, 90-degree turn, or the like to transition from the garage floor to the garage wall.

In these and other embodiments, the CMS 130 may be installed on various surfaces. For example, the CMS 130 may be affixed to a concrete pad, to an asphalt surface such as a parking lot, to the ground including grass, dirt, rock, etc., to walls, and/or ceilings (e.g., concrete walls or ceilings of parking garages, drywall and/or wood walls or ceilings of homes, etc.). The CMS 130 may be affixed to the various surfaces using various mechanical fasteners which may include, but not be limited to, screws, earth screws, masonry screws, bolts, lag bolts, anchors, concrete anchors, expanding anchors, nails, and the like.

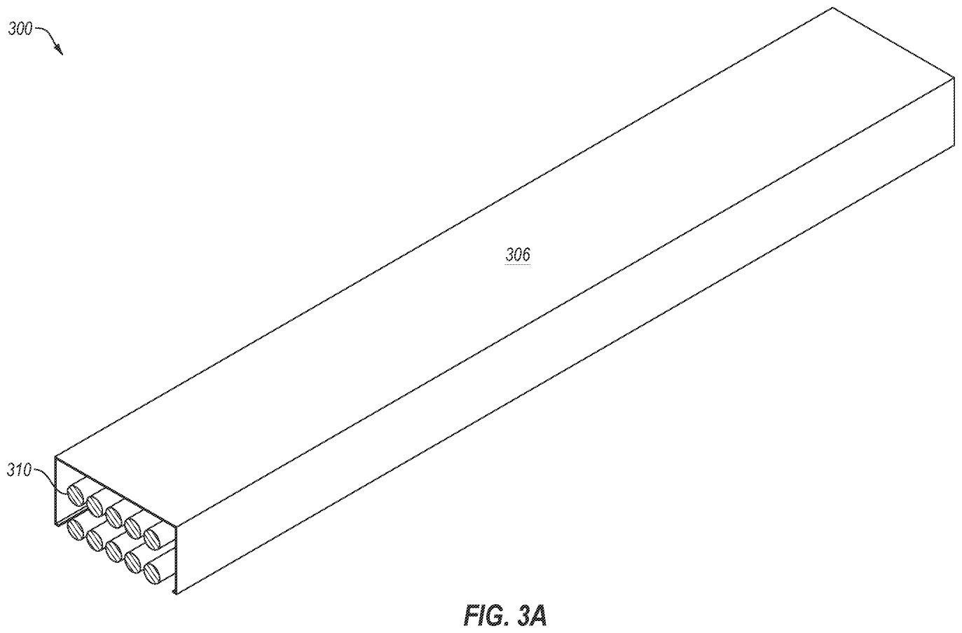

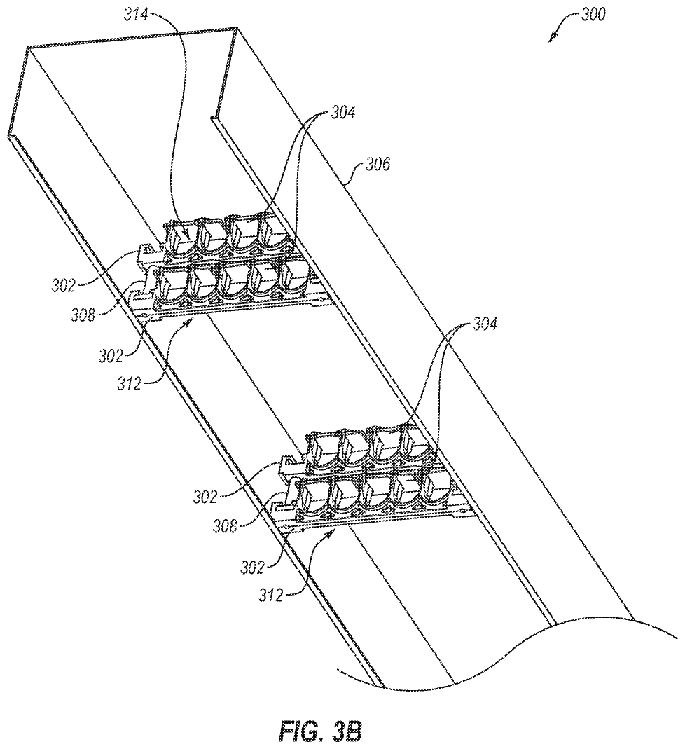

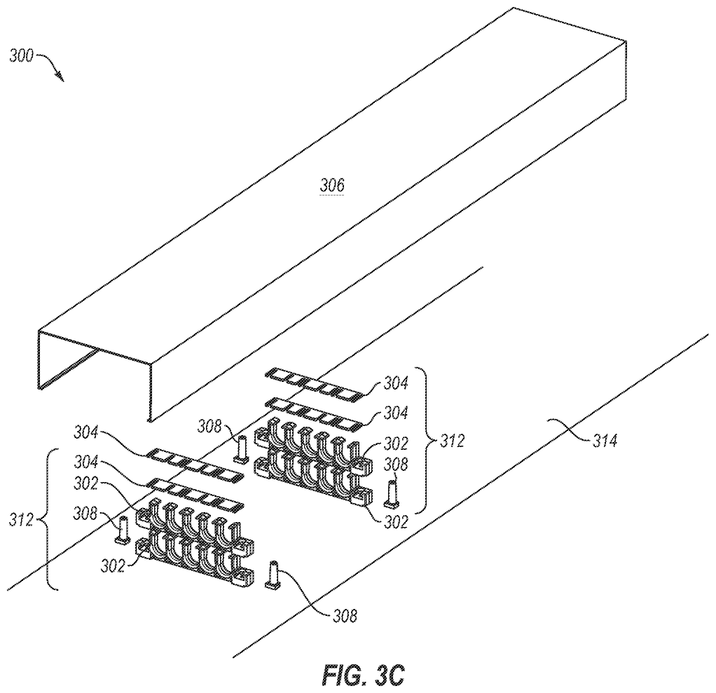

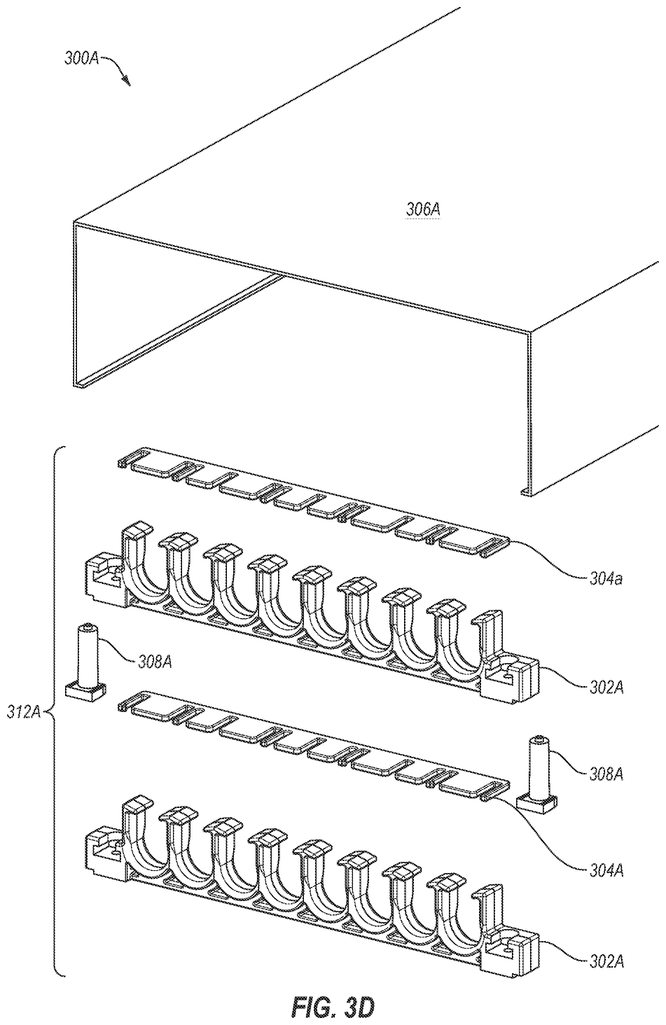

In some embodiments, the CMS 130 may include one or more raceways each made up of a base with a cover portion that may be hingedly attached to the base of the raceway. The hinged cover portion may enable access to an interior portion of the raceway, such as for providing service to the lead assemblies 125 disposed therein. In some embodiments, the CMS 130 may include one or more raceways, one or more multicable clips, one or more retention plates, and/or one or more risers. Each raceway may generally serve as a cover or housing that may be secured to one or more of the other components (e.g., the multicable clips) and/or to an installation surface to at least partially surround and protect the lead assemblies 125 and/or other components disposed therein. Additional details regarding example embodiments of CMSs which may be implemented herein are disclosed in U.S. patent application Ser. No. 18/295,830, filed Apr. 4, 2023, and titled MULTICABLE CLIP, which is incorporated herein by reference in its entirety for all purposes. In addition, some example details regarding the CMS 130 are disclosed in and discussed with respect to FIGS. 3A-3C herein.

In some embodiments, the charger platform 135 may interface with the CMS 130, the lead assemblies 125, and/or the EV. In some embodiments, the charger platform 135 may include a skid base that may include a passageway configured to interface with and/or receive an end of the CMS 130. For example, the passageway may include a complementary size and shape to that of the CMS 130 such that the CMS 130 may pass partially, substantially, or completely through the passageway. The charger platform 135 may cover at least a portion of the CMS 130 such that portions of the lead assemblies 125 within the CMS 130 may exit from the CMS 130 within the charger platform 135 which may limit a hazard to a user. For example, the lead assemblies 125 may be protected and/or enclosed within the CMS 130 and an installation surface with a portion of each lead assembly 125 exiting the CMS 130 within the passageway of the charger platform 135 to electrically couple with the charger platform 135 to provide the power to the EV chargers of the charger platform 135.

In some embodiments, the charger platform 135 may include one or more EV chargers, such as four EV chargers. In some circumstances, it may be beneficial for the charger platform 135 to be located at an intersection of four parking stalls such that up to four EVs may charge from the charger platform 135. The EV chargers may be configured to deliver the output power from the power platform 105A to the electrically coupled EVs during a charging session.

In some embodiments, the EV chargers of the charger platform 135 may each be coupled to a drop line connector of the corresponding lead assembly 125. The drop line connector may be electrically coupled to a distal portion of the corresponding drop line, which drop line may in turn be electrically coupled to the feeder cable at an electrical nexus. In such configuration, the charger platform 135, and more particularly the EV charger(s) therein, may receive output power from the power platform 105A through the feeder cable, drop line, and drop line connector of one of the lead assemblies 125 and may return current through the drop line connector, drop line, and feeder cable of the other lead assembly 125.

In some embodiments, each electrical nexus, or electrical joint, may be configured to support more than one drop line. Alternatively, or additionally, each electrical nexus may include a nexus housing which may surround the electrical nexus and/or a portion of the drop line and/or feeder cable coupled at the electrical nexus. In some embodiments, the nexus housing may include an overmolded design, which may surround the electrical nexus and component parts.

In some embodiments, the nexus housing may include one or more apertures for the electrical lines entering and/or exiting the electrical nexus. In some embodiments, the apertures may include differently sized diameters depending on the size of the cable the aperture is configured to support. For example, the nexus housing may include four apertures: a first large aperture for the feeder cable entering the electrical nexus, a second large aperture for the feeder cable exiting the electrical nexus, and a first and second small aperture for two separate drop lines extending from the electrical nexus. The nexus housing may include more or less apertures depending on the implementation and/or location of the electrical nexus in the system 100A. For example, in the last charger platform 135 of the system 100A, the nexus housing may not include a large aperture for an exiting feeder cable and may include one small aperture for one drop line to support the EV chargers of the last charger platform 135.

In some embodiments, such as those described above, each lead assembly 125 may have one drop line and one drop connector per charger platform 135. In these and other embodiments, and assuming each charger platform 135 has two or more EV chargers, each charger platform 135 may include a distribution panel or other circuitry to electrically couple the single drop line and drop connector of a given lead assembly 125 to each of two or more EV chargers of the charger platform 135. Other embodiments of each lead assembly 125 have one drop line and one drop connector per EV charger. In embodiments in which each lead assembly 125 has one drop line and one drop connector per EV charger and at least one charger platform 135 has two or more EV chargers, each lead assembly 125 may have two or more drop lines and two or more drop connectors for each charger platform 135 that has two or more EV chargers.

In some embodiments, an in-line fuse may be disposed between the drop line and the drop line connector, such as the fuses 425 illustrated and described relative to FIG. 4. Alternatively, or additionally, a charger device circuit breaker may be disposed between the drop line connector and the charger platform 135 and/or EV charger. For example, the charger circuit breaker may be disposed between the drop line and the drop line connector or between the drop line connector and the charger platform 135 and/or EV charger. The charger device circuit breaker associated with the charger platform 135 may be functionally similar to the circuit breakers of the distribution board 115 between the transformer 110 and the lead assemblies 125. For example, the charger device circuit breaker may include an open and closed configuration for electrically coupling/decoupling the charger platform 135 and/or the EV charger to/from the drop line and the charger device circuit breaker may include manual or automatic operations.

FIG. 1A illustrates a single pair of lead assemblies 125 that electrically couple the power platform 105A to one or more charger platforms 135. In some embodiments, the system 100A may include multiple pairs of lead assemblies 125 where each pair electrically couples the power platform 105A to a different set of one or more charger platforms 135. Alternatively, or additionally, each pair of lead assemblies 125 may electrically couple the power platform 105A to a different set of one or more EV chargers. For example, one pair of lead assemblies 125 may electrically couple the power platform 105A to a first set of four EV chargers of a first charger platform 135, another pair of lead assemblies 125 may electrically couple the power platform 105A to a second set of four EV chargers of a second charger platform 135, and so on.

FIG. 1B illustrates a block diagram of another example EV charger system 100B (hereinafter “system 100B”), arranged in accordance with at least one embodiment described herein. The system 100B of FIG. 1B includes many of the same components as the system 100A of FIG. 1A which operate in the same or similar manner across the two systems 100A, 100B such that the associated description need not be repeated here. However, the system 100B includes, instead of the power platform 105A, an EV charger system power platform 105B (hereinafter “power platform 105B”). The power platform 105B generally operates in the same or similar manner as the power platform 105A and includes many of the same components as the power platform 105A which operate in the same or similar manner across the two power platforms 105A, 105B such that the associated description need not be repeated here. However, the power platform 105B omits the power meter 145. As a result, the functionality afforded by the power meter 145 may be absent from the power platform 105B and/or may be integrated into one or more of the other components of the power platform 105B.

FIG. 1C illustrates a block diagram of another example EV charger system 100C (hereinafter “system 100C”), arranged in accordance with at least one embodiment described herein. The system 100C of FIG. 1C includes many of the same components as the system 100A of FIG. 1A which operate in the same or similar manner across the two systems 100A, 100C such that the associated description need not be repeated here. However, the system 100C includes, instead of the power platform 105A, an EV charger system power platform 105C (hereinafter “power platform 105C”). The power platform 105C generally operates in the same or similar manner as the power platform 105A and includes many of the same components as the power platform 105A which operate in the same or similar manner across the two power platforms 105A, 105C such that the associated description need not be repeated here. However, the power platform 105C omits the transformer 110. As a result, the functionality afforded by the transformer 110 may be absent from the power platform 105C and/or may be integrated into one or more of the other components of the power platform 105C. In addition, the power meter 145 is shown in dashed lines in FIG. 1C to indicate that the power meter 145 is optional, i.e., the power meter 145 may be included in the power platform 105C or the power meter 145 may be omitted from the power platform 105C. In an example implementation of power platform 105C in the system 100C of FIG. 1C, the input circuit 120 includes a 208 V panel on a QCB that does not involve or operate with a disconnect or the transformer 110.

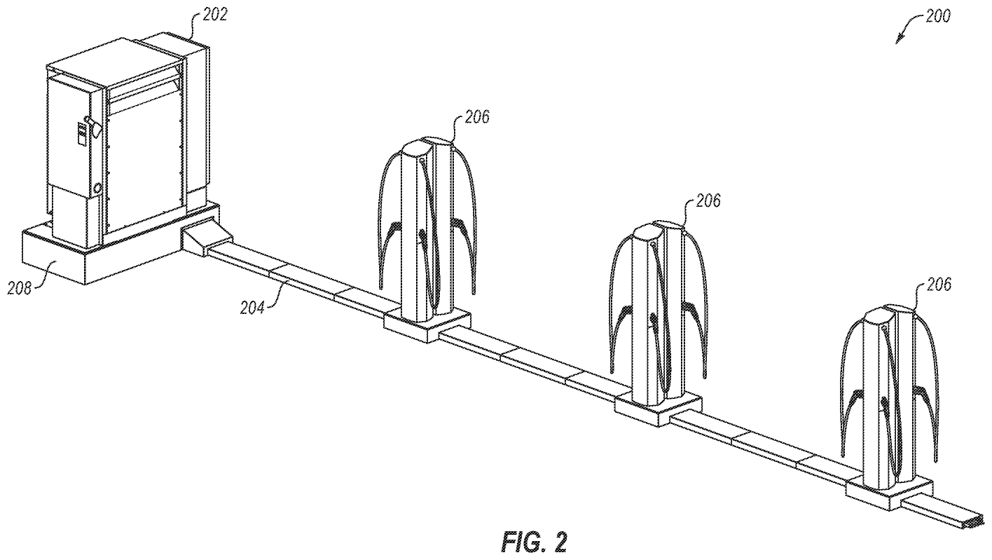

FIG. 2 is a perspective view of an example EV charger system 200 (hereinafter “system 200”) that includes a power platform 202, a CMS 204, two or more lead assemblies and/or other wiring (not shown in FIG. 2), and one or more charger platforms 206, arranged in accordance with at least one embodiment described herein. The power platform 202 may be coupled to a power source (not shown), such as the power source 150 of FIG. 1A. The power platform 202 may be configured to transform power or otherwise condition power from the power source for compatibility with EV vehicles and/or the charger platforms 206. The power platform 202 includes a base 208 that may include, be included in, or correspond to the base 107 of FIGS. 1A-1C.

The system 200 may include, be included in, or correspond to any of the systems 100A-100C (hereinafter generically “systems 100” or “system 100”) of FIGS. 1A-1C. For example, the power platform 202 may include, be included in, or correspond to any of the power platforms 105A-105C (hereinafter generically “power platforms 105” or “power platform 105”) of FIGS. 1A-1C, the CMS 204 may include, be included in, or correspond to the CMS 130 of FIGS. 1A-1C, the lead assemblies and/or other wiring (not shown in FIG. 2) may include, be included in, or correspond to the lead assemblies 125 of FIGS. 1A-1C, and/or the charger platforms 206 may include, be included in, or correspond to the charger platforms 135 of FIGS. 1A-1C.

The charger platforms 206 may be electrically coupled through the lead assemblies to the power platform 202. Each of the charger platforms 206 may include one or more EV chargers which may include, be included in, or correspond to other EV chargers herein. In some embodiments, the EV chargers may be configured to electrically couple to a vehicle or to any other device that may be configured to receive power from the system 200. As illustrated in FIG. 2, each charger platform 206 includes four EV chargers. Alternatively, or additionally, each charger platform 206 may include more or less EV chargers than illustrated. For example, the charger platforms 206 may include one, two, three, four, six, nine, or any other number of EV chargers. In these and other embodiments, each of the charger platforms 206 may be installed at the intersection of four vehicle parking spots or stalls to allow up to four EVs to be charged simultaneously through the charger platforms 206. In instances in which the charger platforms 206 include more than four EV chargers, additional EVs and/or devices may be charged simultaneously with the EVs. For example, an electric motorcycle, a portable battery supply, and/or other devices may be charged concurrently with up to four EVs as the other devices may be sized to fit between the charging EVs.

The CMS 204 may extend between the power platform 202 and at least one of the charger platforms 206 or between two charger platforms 206 to house and secure the lead assemblies. The CMS 204 may eliminate the need for trenching as required in some other EV charger systems as the lead assemblies may be installed above ground and protected within the CMS 204. Although illustrated in FIG. 2 as being routed on the ground or floor (e.g., of a parking lot, parking structure, or the like), more generally the CMS 204 may be routed on any installation surface or structure, such as a floor, a wall, a ceiling, or other installation surface.

FIGS. 3A-3C illustrate an example CMS 300, arranged in accordance with at least one embodiment described herein. The CMS 300 may include, be included in, or correspond to the CMS 204 of FIG. 2 and/or the CMS 130 of FIGS. 1A-1C. FIGS. 3A, 3B, and 3C respectively include a top front perspective view, a bottom front perspective view, and an exploded top front perspective view of the CMS 300. As illustrated, the CMS 300 may include one or more multicable clips 302, one or more retention plates 304, a cable raceway 306 (which may include, be included in, or correspond to other raceways herein), and/or one or more risers 308. FIG. 3A additionally illustrates example feeder cables 310 that may be managed, protected, and/or housed by the CMS 300. The feeder cables 310 may be part of corresponding lead assemblies, such as the lead assemblies 125 of FIGS. 1A-1C, and/or may be the same as or similar to other feeder cables herein. Only one of the feeder cables 310 is labeled in FIG. 3A for simplicity. The feeder cables 310 are omitted from FIGS. 3B and 3C for clarity.

Each multicable clip 302 includes multiple channels to receive and secure multiple feeder cables 310. For example, each of the multicable clips 302 illustrated in FIGS. 3B and 3C includes five channels to receive and secure five feeder cables 310. FIG. 3D illustrates an alternative embodiment of a CMS 300A in which each multicable clip 302A includes eight channels to receive and secure eight feeder cables (not shown in FIG. 3D). More generally, the number of channels included in each multicable clip may be one or more, such as five or eight as illustrated in FIGS. 3B-3D, three, seven, ten, or other desired number of channels. Additionally, while each of the channels in the multicable clips 302 have been described as receiving and securing a single feeder cable 310 in each channel, more generally each channel may receive and secure one or more feeder cables 310, such as two feeder cables 310 per channel, three feeder cables 310 per channel, or other number of feeder cables per channel. The dimensions of each channel and/or feeder cable may be selected according to the number of feeder cables to be received in each channel. In these and other embodiments, the number of feeder cables 310 that may be included in the CMS 300 may be determined based on the National Electric Code. The retention plates 304 or 304A couple to the multicable clips 302 or 302A to retain the feeder cables 310 in the channels after placement therein. As illustrated, each of the multicable clips 302, 302A may be stacked with another multicable clip 302, 302A through the risers 308, 308A. The risers 308, 308A couple the multicable clips 302, 302A together (optionally with one or more threaded fasteners or other fasteners).

A set of stacked multicable clips 302, 302A together with corresponding retention plates 304, 304A and risers 308, 308A (and optional fasteners) may be referred to herein as a stacked retention assembly 312, 321A. Two stacked retention assemblies 312 are at least partially visible in each of FIGS. 3B and 3C and one stacked retention assembly 312A is visible in FIG. 3D. The stacked retention assemblies 312, 312A may be spaced apart along a length of the cable raceway 306, 306A to provide support and management of the feeder cables 310 along the length of the cable raceway 306, 306A. For example, the stacked retention assemblies 312, 312A may be spaced every 18 to 24 inches. By stacking multiple multicable clips 302, 302A together, each stacked retention assembly 312, 312A may secure in a single location along the length of the cable raceway 306, 306A more feeder cables 310 than a single multicable clip 302, 302A by itself. The illustrated embodiment of FIGS. 3A-3C depicts ten feeder cables 310 secured by each of the stacked retention assemblies 312 which is twice as many as one of the multicable clips 302 alone. Similarly, in the embodiment of FIG. 3D, the stacked retention assembly 312A may secure sixteen feeder cables (assuming there is one feeder cable per channel), which is twice as many as one of the multicable clips 302A alone.

Within each stacked retention assembly 312, 312A, one of the multicable clips 302, 302A will be closer to and/or coupled directly to an installation surface 314 while the other multicable clip(s) 302, 302A is(are) spaced further from the installation surface 314. The multicable clip 302 that is closest to and/or coupled directly to the installation surface 314 may be referred to herein as a base multicable clip 302, 302A. The multicable clip(s) 302, 302A that is(are) spaced further from the installation surface 314 than the base multicable clip 302, 302A may be referred to herein as the elevated multicable clip(s) 302, 302A because it is spaced apart from or elevated relative to the installation surface 314. The use of “base” and “elevated” in describing the multicable clips 302, 302A in stacked retention assemblies 312, 312A should not be construed to require that the stacked retention assemblies 312, 312A have a particular orientation relative to any given reference frame. Rather, the use of “base” and “elevated” in describing the multicable clips 302, 302A in stacked retention assemblies 312, 312A is merely used as an aid in distinguishing between the multicable clips 302, 302A in a stacked retention assembly 312, 312A notwithstanding any particular orientation they may have relative to a given reference frame. In FIG. 3C, the installation surface 314 may be a floor or ground (i.e., gravity is down in the orientation of FIG. 3C) such that the multicable clip 302 at the bottom of each stacked retention assembly 312 is the base multicable clip 302 while the other multicable clip 302 in each stacked retention assembly 312 is the elevated multicable clip 302. If the installation surface 314 were instead a ceiling surface (i.e., gravity is up in the orientation of FIG. 3C), the multicable clip 302 that is closest to the installation surface 314 would still be referred to as the base multicable clip 302 and the multicable clip 302 that is furthest from the installation surface 314 would still be referred to as the elevated multicable clip 302 despite being lower than the base multicable clip 302 relative to the gravitational reference frame.

The cable raceway 306, 306A may be configured to engage at least one of the multicable clips of each stacked retention assembly 312, 312A along its length to at least partially enclose the stacked retention assemblies 312, 312A (or portions thereof) and the feeder cables 310. For example, a retention flange or other structure of the cable raceway 306, 306A may be configured to engage a shoulder or other structure defined in a bottom of each base multicable clip 302, 302A.

Substitutions, modifications, additions, etc. may be made to FIGS. 3A-3D without altering the scope of the disclosure. For example, the CMS 300, 300A may have a single multicable clip 302, 302A and retention plate 304, 304A at each supported location along the length of the cables 310 instead of a stacked retention assembly 312, 312A. Alternatively or additionally, while a height of the cable raceway 306, 306A is illustrated as accommodating a base multicable clip 302, 302A and one elevated multicable clip 302, 302A, the height of the cable raceway 306, 306A may be reduced to accommodate a single multicable clip 302, 302A (e.g., a base multicable clip 302, 302A without any elevated multicable clips 302, 302A) or increased to accommodate three or more multicable clips 302, 302A (e.g., a base multicable clip 302, 302A with two or more elevated multicable clips 302, 302A) in a given stacked retention assembly 312, 312A.

FIG. 4 illustrates a portion of a lead assembly 400, arranged in accordance with at least one embodiment described herein. The lead assembly 400 may include a feeder cable 405, electrical nexuses 410, drop lines 415, drop line connectors 420, and fuses 425. The lead assembly 400 may include, be included in, or correspond to other lead assemblies herein, such as the lead assemblies 125 of FIGS. 1A-1C. Similarly, the feeder cable 405, the electrical nexuses 410, the drop lines 415, the drop line connectors 420, and the fuses 425 may respectively include, be included in, or otherwise correspond to other feeder cables, electrical nexuses, drop lines, drop line connectors, and fuses herein.

The lead assembly 400 generally includes the drop lines 415 electrically coupled to the feeder cable 405 at the electrical nexuses 410. In some embodiments, the drop lines 415 and the feeder cable 405 may be held together by a compression lug, which may include an undermold and/or an overmold. In some embodiments, the overmold may define at least one aperture for receiving zip-ties, and the like, for securing the lead assembly 400 upon installation. For example, a zip-tie through the corresponding aperture of the overmold may be used to couple the electrical nexus 410 to a portion of a CMS, such as to any of the multicable clips 302.

Each of the drop lines 415 may terminate in a corresponding one of the drop line connectors 420. Each drop line connector 420 may be configured to electrically and/or mechanically couple the lead assembly 400 to a corresponding charger platform and/or EV charger. The drop lines 415 may be constructed of 18 to 4 gauge wire, and drop line connectors 420 may be off-the-shelf connectors such as MC4/PV-KBT4/6I-UR & PV-KST4/6I-UR from STÄUBLI Electrical Connectors of Windsor, California. Each of the electrical nexuses 410 of the lead assembly 400 may include a single drop line 415, as illustrated, or dual drop lines, such as the drop lines 515 illustrated in FIG. 5, where each drop line may be electrically coupled to a different corresponding charger platform or EV charger.

In some embodiments, the fuses 425 may be disposed between the drop lines 415 and the drop line connectors 420. In some embodiments, the fuses 425 may be configured to protect at least the drop lines 415 and/or a connected device like a charging system, such as the charger platforms 135 of FIG. 1A. The fuses 425 may be configured to sever the electrical connections between the drop lines 415 and the connected devices in instances in which a current through the fuses 425 is greater than a threshold amount. Alternatively, or additionally, one or more fuses or circuit breakers may be disposed between the feeder cable 405 and each drop line 415, such as within the corresponding electrical nexus 410, to protect each drop line 415 and any other downstream device(s) such as the charger platforms 135 of FIGS. 1A-1C.

In some embodiments, the lead assembly 400 can be modified to accommodate different charger platforms and/or EV charger systems. For example, the electrical nexuses 410 and the drop lines 415 may be spaced close together (e.g., such as approximately every 15 centimeters (cm)), or far apart (e.g., such as approximately every 15000 cm), or any other desired distance, along the feeder cable 405, depending on spacings and/or locations of the charger platforms and/or EV chargers. Also, spacing of the electrical nexuses 410 and the drop lines 415 can vary on a single lead assembly. For example, one section of the lead assembly 400 may space the electrical nexuses 410 and the drop lines 415 every three meters (m) while another section may space the electricalnexuses 410 and the drop lines 415 every 10 m.

At least one end of the feeder cables 405 may terminate in a feeder cable connector (not illustrated), which feeder cable connector may be configured to electrically and/or mechanically couple the feeder cable 405 to a power conversion device, such as the power platform 105 and/or to the distribution board 115 or other component of the power platform 105. In some embodiments, the feeder cable 405 may be electrically coupled to a jumper, which may be an “extension cord” device between the feeder cable 405 and the power conversion device which may be economical to use in some configurations, for example where portions of feeder cable 405 may be installed at different times. In another situation, the jumper could be buried underground and the feeder cable 405 above ground. Being able to install the feeder cable 405 and the jumper independent of one another can offer much more flexibility. The jumper could also be utilized if there are a significant number of varying lengths from charger platforms or EV chargers to the power conversion device. The jumper could also be utilized if there is a substantial distance (e.g., greater than 50 meters) to travel from charger platforms or EV chargers to the power conversion device and it may be wasteful to use the lead assembly 400 with unused drop lines 415. The other end of the feeder cable 405 may terminate in a most distal one of the electrical nexuses 410, which may be installed at the charger platform or EV charger located furthest from the power conversion device. In alternative embodiments, the feeder cable 405 includes a feeder cable connector at both terminal ends so feeder cables 405 can be connected one-to-another in an end-to-end orientation. In yet another embodiment, one or both ends of feeder cables 405 are blunt cut for subsequent manual connection, for example stripping and crimping to connectors or other segments of feeder cable 405.

The feeder cable 405 may be constructed of 6 gauge to 1000 MCM wire, with the specific wire chosen based on factors such as the number of drop lines 415, the distance between the charger platform or EV charger and a power conversion device, and whether or not feeder cable 405 is of aluminum or copper construction. The feeder cable connectors may include off-the-shelf connectors such as KBT10BV & KST10BV from STÄUBLI Electrical Connectors of Windsor, California.

As described herein, the drop lines 415 and the feeder cable 405 may be electrically and/or mechanically coupled at the electrical nexuses 410. This may be accomplished by stripping wire insulation from corresponding segments of the drop lines 415 and the feeder cable 405, adjoining respective segments of exposed wire, and securing contact between the segments of exposed wire by employing a compression lug. It should be understood that securing contact between the segments could be achieved by other means including soldering, splicing, crimping, and so forth. The compression lug may be surrounded by an undermold, which may be composed of RTP 2099Ex127663 from RTP Co. of Winona, Minn. or other material, that may be applied by injection molding. In some embodiments, the undermold may be surrounded by an overmold, which may be composed of RTP 199×124807 from RTP Co of Winona, Minn. or other material, that may be applied by injection molding. The resulting lead assembly 400 may be profoundly durable, resistant to environmental factors such as temperature fluctuations, debris, and moisture, and may be strong enough to be buried.

Additional details regarding example embodiments of lead assemblies which may be implemented herein in connection with EV charger systems are disclosed in U.S. Pat. No. 10,992,254, as described above.

FIG. 5 illustrates a portion of another lead assembly 500, arranged in accordance with at least one embodiment described herein. The lead assembly 500 may include a feeder cable 505, an electrical nexus 510, and drop lines 515.

In some embodiments, the portion of the lead assembly 500 may be the same as or similar to the lead assembly 400 illustrated in FIG. 4 and/or other lead assemblies herein. For example, the feeder cable 505, the electrical nexus 510, and the drop lines 515 may be the same as or similar to the feeder cable 405 of FIG. 4 or other feeder cables herein, the electrical nexuses 410 of FIG. 4 or other electrical nexuses herein, and the drop lines 415 of FIG. 4 or other drop lines herein.

As illustrated, the lead assembly 500 includes more than one drop line 515 coupled to the feeder cable 405 at the electrical nexus 510. Each drop line 515 electrically coupled to the feeder cable 405 may be electrically coupled to a charger platform or an EV charger. The lead assembly 500 and in particular, the two drop lines 515, may support more than one charger platform or EV charger in close proximity to another charger platform or EV charger. For example, the two drop lines 515 may each electrically couple to a different charger platform or EV charger such that two charger platforms or EV chargers may be in close proximity to one another.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A system to charge electric vehicles comprising:
a power platform configured to receive input power and to generate output power from the input power;
a cable management system (CMS) extending from the power platform;
two or more lead assemblies each including a feeder cable electrically coupled to the power platform and a drop line electrically coupled to the feeder cable, the lead assemblies disposed in the CMS; and
a charger platform configured to interface with the CMS and support a charging device, the charging device electrically coupled to the drop line and including an electric vehicle (EV) charger configured to deliver the output power to an electric vehicle,
wherein the power platform is configured to electrically protect the lead assemblies and the charger platform.

2. The system of claim 1, wherein the power platform further comprises:
a transformer configured to transform the input power to the output power;
a distribution board electrically coupled between the transformer and the lead assemblies; and
an input circuit electrically coupled between a utility wire and the transformer, the utility wire configured to carry the input power from a power source to the transformer.

3. The system of claim 2, wherein the transformer, the distribution board, and the input circuit are electrically coupled together via one or more electrical lines.

4. The system of claim 3, wherein the one or more electrical lines electrically couple the transformer, the distribution board, and the input circuit to the feeder cable.

5. The system of claim 2, wherein the transformer, the distribution board, and the input circuit are each interlocking, plug-and-play components and together, integrally form the power platform.

6. The system of claim 2, wherein the distribution board includes an electrical switch having an open configuration and a closed configuration, wherein in the open configuration, the lead assemblies are electrically decoupled from the power platform, and in the closed configuration, the lead assemblies are electrically coupled to the power platform.

7. The system of claim 2, wherein the input circuit includes an electrical switch having an open configuration and a closed configuration, wherein in the open configuration, the transformer is electrically decoupled from the utility wire, and in the closed configuration, the transformer is electrically coupled to the utility wire.

8. The system of claim 1, wherein the output power is a direct current (DC) power.

9. The system of claim 1, wherein the output power is an alternating current (AC) power.

10. The system of claim 1, wherein the CMS includes one or more raceways each made up of a base with a cover portion coupled to the base that forms one or more channels to receive the lead assemblies.

11. The system of claim 1, wherein the CMS extends across a surface on which the power platform is installed.

12. The system of claim 1, wherein the drop line includes a drop line connector disposed on a distal end thereof, the drop line connector configured to electrically interface with the charging device.

13. The system of claim 1, further comprising a fuse disposed in line with the drop line.

14. The system of claim 1, wherein the drop line is electrically coupled to the feeder cable at an electrical nexus, the lead assemblies further comprising a second drop line electrically coupled to the feeder cable at the electrical nexus.

15. The system of claim 14, wherein the electrical nexus is positioned within a nexus housing, the nexus housing including at least a first aperture having a first diameter configured to receive the feeder cable and a second aperture having a second diameter configured to receive the drop line, wherein the second diameter is smaller than the first diameter.

16. The system of claim 1, wherein the charger platform comprises a base defining a passageway to encase a portion of the CMS.

17. The system of claim 1, further comprising a charging device circuit breaker electrically coupled between the drop line and the EV charger.

18. The system of claim 17, wherein the charging device circuit breaker includes an open configuration and a closed configuration, wherein in the open configuration, the EV charger is electrically decoupled from the drop line, and in the closed configuration, the EV charger is electrically coupled to the drop line.

19. The system of claim 1, further comprising a plurality of charging device circuit breakers electrically coupled between a plurality of drop lines and a plurality of EV chargers, the plurality of drop lines each electrically coupled to the feeder cable.

20. The system of claim 19, wherein a first charging device circuit breaker of the plurality of charging device circuit breakers includes an open configuration and a closed configuration, wherein in the open configuration, a first EV charger of the plurality of EV chargers is electrically decoupled from a first drop line of the plurality of drop lines, and in the closed configuration, the first EV charger is electrically coupled to the first drop line.

21. The system of claim 1, wherein the power platform, the CMS, the lead assemblies, and the charger platform are each installed above ground level.
